(19) United States
(12) Patent Application Publication
(10) Pub. No.: US 2014/0327775 A1
(43) Pub. Date: Nov. 6, 2014

(54) Mirrorless Driving of Automotive Vehicle Using Digital Image Sensors and Touchscreen

(71) Applicant: Kyu Hwang Cho, Fairfield, CA (US)

(72) Inventor: Kyu Hwang Cho, Fairfield, CA (US)

(21) Appl. No.: 14/332,040

(22) Filed: Jul. 15, 2014

Related U.S. Application Data
(60) Provisional application No. 61/911,752, filed on Dec. 4, 2013.

(51) Int. Cl. B60R 1/08; G06F 3/01; H04N 5/232

(52) U.S. Cl. CPC B60R 1/08; H04N 5/23216; G06F 3/016
USPC 348/148

(57) ABSTRACT

Automotive mirrors may be replaced by a multi-lens-equipped touchscreen to enable mirrorless driving that may help open a new avenue for identifying energy-saving and environment-friendly solutions to enhance driving safety by harnessing vehicle traffic to incentivize a mixed reality. The mirrorless driving may eventually encompass not just vehicular black boxes and rearview backup cameras but also ADAS (Advanced Driver Assistance System).

### REFERENCE TO RELATED APPLICATION

The present invention seeks to claim priority on a Provisional Application No. 61/911,752 that was filed on Dec. 4, 2013.

### NO NEW MATTER STATEMENT

The present specification is a substitute specification prepared in compliance with 37 CFR 1.52 and 1.12(b)(3), and 1.25. The applicant hereby states that no new matter has been added to the non-compliant specification filed on 15 Jul. 2014. No other correction or amendment has been made to the non-compliant version, with the exception of this “no new matter statement”. No correction or amendment has been made even to a specification submitted with the provisional application #61/911,752, except for one typo in para [0102].

### TECHNICAL FIELD

The invention pertains to automotive telematics and ITS.

### BACKGROUND ART

Prior art includes the conventional factory-installed rearview mirrors and side mirrors plus mirror adjustment mechanisms. Also included are aftermarket replacements for the conventional auto mirrors. One of them are Allview™ mirrors, which are a rearview mirror enhancement aiming to expand a driver's surround views.

Also, related prior art includes in-dash navigation systems, touchscreen, digital camera lenses, electro-optical sensors, rearview backup cameras, EDR, AACR, self-driving cars, Europe's SARTRE project, and IVI platforms, like Tizen.

Catalytic converters are an automotive device for reduction reaction of toxic tailpipe emissions. This invention has no technological resemblance to catalytic converters but has a common ground in emissions reduction initiatives.

### SUMMARY OF INVENTION

### Technical Problem

The global car density is growing exponentially. Naturally, fuel efficiency and driving safety pose the biggest challenges ever. Energy resources are depleting globally, and roads are getting crowded and life-threatening. Worse still, the soaring GHG emissions have apparently become an environmental time bomb.

Improving fuel economy for automotive vehicles is unequivocally crucial to energy security and global economy accordingly. Saving fossil fuel for vehicles is also mission critical to curbing GHG emissions into atmosphere, which are believed to trigger climate change.

Making cars lighter, designing them more aerodynamically streamlined, and enhancing alternative energy initiatives may be a micro way of improving fuel economy. However, as a way of big-picture thinking, improving driving safety and curbing traffic congestions are no less or perhaps by far more mission critical to fuel economy and GHG-laden environment.

To achieve a major breakthrough in both driving safety and fuel economy, a holistic approach in automobile design and engineering cannot be too much emphasized. The auto holism is meant to harness the growing interdependence between cars on the roads. And the car-to-car interdependence is raising the bar for sophistication in driving safety as mobile broadband technology steps in.

Some holistic attempts, like self-driving cars, vehicle platooning also known as road trains, and the energy-sharing V2G technology, have been made with a slight mix of swarm intelligence over decades, but still there are a bunch of weak links to turn such holistic experiments into real-world implementation.

The thing is that no decentralized type of peer-to-peer connectivity nodes between cars have been at work so far. Sensor networks linking cars and infrastructure have been talked about vehemently, but in real life, there are too many weak links.

The auto holism may possibly offer a metaheuristic solution toward the said challenges based on the hard fact that each car on the road is a decentralized and moving component of a cluster of wayward vehicle traffic that has a head, a body and a tail, as analogous to fish schooling.

The holistic tenet, if incentivized by a great potential of P2P leverage to harness vehicle traffic, will hopefully promote a consensus of altruistic and mutualistic performances for each car on the road to improve fuel economy and road safety, as we all know even one driver may happen to raise havoc with traffic. Refer to a news article entitled “Driver sent or got 11 texts in 11 min before crash” dated Dec. 13, 2011.

Nonetheless, automobiles are being built as an independent unit that is gradually losing its collective significance as a constituent part of vehicle traffic. To counter this waning collective significance, there comes an urgent need for identifying wireless nodes that can link cars for exploiting algorithmic swarm intelligence so as to promote the collective interest of drivers and thus head off the prevalence of the prisoner's dilemma that is compromising road traffic safety.

The up-to-date automotive design criteria may tend to leave no stones unturned in search for every nook and cranny of a car to reduce energy consumption by even a single drop of fossil fuel, along with alternative energy initiatives, are ever more mission-critical. Perhaps in this regard, wing mirrors might have worn out their welcome, the way they are causing a lot of “form drag” that does waste away hydrocarbon fuel and also increase carbon footprints deleteriously.

Globally combined together, vehicle body weight could be reduced substantially if auto mirrors were removed. A couple of pounds reduced per vehicle by removing auto mirrors could be huge at a global scale. Just imagine that over 77 million new motor vehicles were produced in 2010, 26% up from 2009, according to statistics released by OICA. Moreover, as many vehicles are rolling off production lines every year.

Tunas, allegedly the fastest fish ever, are known to fold down their fins into body grooves in order to reduce drag, when not necessary for maneuver and also when necessary to increase their speeds. On the contrary, cars don't have this energy-conscious mechanism of folding down wing mirrors to reduce drag, as opposed to tunas. It is noteworthy that airplanes do not have wing mirrors. Biomimetic has a role to play here.

Meantime, the big-picture approach to meet the aforementioned challenges might be associated directly with how to harness the increasing interdependence between cars. Harnessing it should hopefully be initiated bottom up, instead of bottom down. Such being the case, V2V connectivity nodes with a potential P2P leverage are gaining urgency than ever before. And it makes more sense at a time when the lure of on-screen IVI features is adding a new problem to the chronic state of blind spots caused by auto mirrors,

The rationale is that such conventional means of car-to-car communications, like turn signals, are losing their glamor, being gradually ignored by drivers, and, more likely, look vestigial, thereby jeopardizing road safety. To overcome the drawback of such conventional means, a mixed reality, which is a sum of an augmented reality and an augmented virtuality, should be extensively exploited to find a realistic way to incentivize drivers, in addition to wireless connectivity of cars.

Besides, wing mirrors are fragile and vulnerable to even minor accidents, thus making replacements very costly. Replacement costs per unit are currently estimated at between $120 and $500 excluding labor costs. In the worst case scenario, such minor damages might induce excessive insurance claims enough to beat a high deductible.

Wing mirrors are easy to get hazy, misty and blurred in rainy and foggy weather, and get frosty in winter, causing optical illusions leading directly to car accidents. Not to speak of car accidents, such annoying chores as drying up, defogging and defrosting wing mirrors in extreme weather conditions may end up frustrating drivers with overfatigue, especially when they are pressed for time.

Wing mirrors are one of the reasons why vehicles cause irritating sun glare against one another unknowingly, thereby leading to a serious visibility issue, road rages and even accidents. Surely, “driving and sun glare can be a deadly mixture”, according to a 2002 PRNewswire article.

Even a fender bender ascribable to unhappy instances of sun glare or foggy weather might delay vehicle traffic over an hour, thereby causing a huge waste of energy and human afflictions, and even spawning a horrendous pileup in the worst case. Reference is made to a foggy 50-car pileup near Nashville reported by AP, Dec. 1, 2011.

Of course, wing mirrors are not the only source of sun glare. Sun glare can also come from snow, ice, sunset, and other external elements on top of reflective vehicle surfaces, including chrome decorations, car windows, and windshield. Even at night, auto mirrors make drivers suffer from headlight glare, and the results are visibility problems, road rages and even accidents.

Admittedly, a “night vision” technology is in wide use to dim rearview mirrors at night, but is not workable for side-view mirrors. Adjusting wing mirrors and rearview mirrors at night to avoid headlamp glare is cumbersome and at times risky.

When adjusting auto mirrors, the best-viewing directions, once adjusted, should remain fixed “as is” for days, weeks, months or years. So, adjusting mirrors repeatedly at the wheel can divert a driver's attention unnecessarily and therefore is discouraged simply because the driver must keep his eyes on the road all the time.

Wing mirrors get costlier to manufacture due to supply chain issues. Obviously, they need some mechanical moving parts like mirror adjusters requiring two small 12-VDC motors with push/pull worm-gear mechanisms, respectively. Power consumption by mechanical mirror adjusters is unequivocally minimal and sporadic, but repairs are still costly.

And automotive mirrors are much heavier than electronic components, insofar as reduction of vehicle body weight matters most. Housings of wing mirrors, mostly made of ABS, can be made from a lighter material like carbon fiber, but can do nothing much with GVWR.

Auto mirrors have their visibility limitations due to blind spots caused. Let alone big rigs, even Class 3 trucks can hardly see smaller vehicles running side by side at a dead angle or in a blind spot. Prior art known as Allview™ is to cure this blind spot disadvantage resulting from OEM mirrors by materializing an all-around view in a rearview mirror. Depending on its installed height, Allview™ can help decrease blind spots, but is still far from guaranteeing a full visibility.

EDRs better known as automotive black boxes come in either 2-channel or multi-channel models. The base model provides 2-channel views: an inside view targeted at a driver and a front view. The drawback is that EDRs are basically a centralized system. So they are intended to immediately propagate to police and insurance carriers both video clips and related data events recorded for a short span of time before and after any car crash.

Being centralized, EDRs can cut both ways. On the flip side, privacy concerns and lack of wireless V2V connectivity revolving EDRs may hamper a potential advantage in synergizing the auto holism and user-centricity in P2P potentials leveraging any possible V2V connectivity.

There were times when automobiles had no navigation and/or IVI screen. In those days, auto mirrors didn't cause as much burden of distracted driving as they do today. A navigation screen with spawning telematic features has become a necessary evil that consumes more of driver attention than ever before, only to make auto mirrors burdensome.

Inevitably, such a touchscreen technology requires more interactive and compelling responses from drivers than auto mirrors do. There has been a paradigm shift going on as to how drivers at the wheel have to interact with their surroundings. Now they just don't look into mirrors to drive cars, but also deal with on-screen images and instructions compelling their immediate attention.

A recent study of 1,000 drivers revealed a strong demand for new in-car technologies, including wireless communications and advanced navigation, according to a research from Altman Vilandrie & Company.

Meanwhile, smartphones are rushing to find their way into vehicle dashboards with their inserting docks being increasingly installed so that smartphone apps come into play in automotive dashtop. This contributes further to worsening driver distraction, in spite of their convenience.

Besides, PND and tablet computers as well are gradually taking a new lease on life on vehicular dashboards and windshields, which phenomenon can be described as “dashtop sprawl”. Worse still, even sun visors and steering wheels are being inundated with such AACR devices and IVI gadgets.

To help a driver stay focused more on driving, the driver has to be given some relief from the growing physical burden of turning his head, not only right and left, but also in every direction much too often to pay attention at the growing list of attention-grabbing new gadgets, while at the wheel.

Besides wing mirrors, drivers have to look at a rearview mirror, an instrument panel, a navigation screen, a screen for rearview backup camera, gadget-mounted sun visors, buttons at the steering wheel and some aftermarket IVI gadgets connected to a console box and car chargers. And front-end voice activation features, too.

As more new models of cars come with one or more screens for navigation plus IVI features, more and more of driver attention is migrating to a screen or two in the center of a vehicle dashboard, let alone backseat screens. For example, Lexus showed the LF-LC concept car with two 12.3-inch screens, one for information and one for navigation, plus a keyboard for entering information. [article: Will concept cars ignite the telematics market? Jan. 19, 2012 by Susan Kuchinskas]

Even older models may require a lot more portable devices for drivers to carry and look at or take care of, while driving. It goes without saying that the increased chances of looking at portable mobile devices plus a center screen might distract drivers further more by causing a focus split. The median lifespan of passenger cars in USA is allegedly 9.2 years.

However, it is unthinkable to turn back the clock to get back to an era, when there were no navigation screen, no smartphones, and no IVI devices inside a car. Ironically enough, however, the same amount of driver attention given to wing mirrors as much as before the advent of navigation screen and/or IVI devices has grown more burdensome for now.

Both globally and individually combined, it is not too far-fetched to say that wing mirrors may be obsolescent, contributing to a big waste in energy and a slow but ongoing progress of devastating consequences of increased carbon footprint. Moreover, the growing car density in emerging markets will drastically accelerate this drag-related impact on energy waste and CO2 gas emissions in spite of the Durban climate deal of December 2011.

A gradual migration to the touchscreen technology is conspicuously witnessed in the auto industry the world over. However, touchscreen features do not have to monopolize driver attention to such an extent as to put the cart before the horse. Simply put, in-vehicle touchscreens should not take a driver's eyes off the road too much.

So, an ergonomic solution optimizing the touchscreen and digital imaging technology is eagerly sought for. The emerging telematic ecosystem is required to be something more than just a replica or an eclectic mix of operational platforms related to desktop PC and portable mobile devices, particularly in consideration of the evolving versatility of human-to-computer modality.

### Solution to Problem

Mirrorless driving may possibly offer a synergistic solution optimizing both the direct way of improving fuel economy and the big-picture thinking strategy of enhancing road safety geared to streamline traffic surges in urban areas, of which worsening traffic congestions contributes to wasting energy and polluting atmosphere.

The mirrorless driving may reduce not just vehicle body weight by removing auto mirrors but also eliminate the form drag caused by wing mirrors, with the result that drivers can save energy and incidentally curb GHG emissions into atmosphere. More important, guaranteeing a full visibility by removing auto mirrors can open a new horizon for road safety, which is increasingly regarded as a big-picture solution to fuel economy.

The mirrorless driving can be realized by having auto mirrors supplanted by a plurality of digital camera lenses coupled to a touchscreen. The plurality of digital lenses provides a better visibility than auto mirrors and upgrades the current scope of driving safety to a new dimension by incentivizing a mixed reality.

The mixed reality may comprise an overlay of graphic images over real-time street scenes and/or traffic scenes displayed on a touchscreen. Self-generated on-screen graphic alerts and electronic voice warnings plus virtual on-screen road signs might be an urgent necessity to raise awareness of driving safety, which is ultimately a macro way of saving energy for all the drivers. Digital maps for navigation can optionally be superimposed over the real-time captures of street and/or traffic scenes.

The remotely controllable digital lenses supported by UI can open an avenue of incentivizing drivers to abandon heedless self-interests but realize that voluntary altruistic driving behaviors might ultimately help themselves, as opposed to the current way of mirror-reliant driving.

This solution of mirrorless driving can help leash up a monster lurking in our daily driving habits and can give an incentive to promote self-restraints by enabling a verified metric on how to self-evaluate a driver's daily driving behaviors. This self-evaluation can be optionally turned into an accumulative report that may be presented to insurance carriers at a driver's discretion to get a lower premium or a good driver's discount, as opposed to insurance telematics, of which top-down approaches might tend to infringe on a driver's privacy.

With the auto holism geared to such on-screen graphic signs of alerts and warnings in an A/V format, passenger cars can be self-tamed to significantly reduce almost all sorts of risks related to driving safety and will most likely help avoid even road rages. By doing so, obtrusive monitoring by insurance carriers of individual driving behaviors could be compromised enough to address privacy concerns and moral hazards on the part of the insured, against the backdrop of burgeoning insurance telematics.

The improved driving safety thus achieved can ultimately address a majority of traffic congestions, and eventually save a huge waste of energy, environmental hazards as GHG emissions, and human sufferings as well. If a rate of car accidents were to reduce by one per day, it might help a lot of other drivers as well as the drivers in accidents save energy and our environment in the end.

Disruptive it may sound, a series of successful road tests of self-driving cars in recent years have proven auto mirrors are no longer essential. Simply put, cars can run safely without auto mirrors. However, driverless driving still remains a distant reality for the mass market until it reaches a technology shakedown. Besides, one major drawback of driverless driving is a psychological aspect that a driver might lose a sense of belonging to his/her driverless car, only to make him or her feel like a passenger or a backseat driver.

With auto mirrors removed, the invention can still help drivers keep their eyes on the on-screen “virtual” roads, if not physical. In addition, eliminating auto mirrors can help reduce body weight of cars by at least a couple of pounds per vehicle, too. Globally, over 1 billion motor vehicles were registered to run on the roads as of 2010, according to a research by WardsAuto.com.

Current ways of looking at a driver's surroundings in every direction are diverted and decentralized. This problem can be addressed substantially by centralizing it in one screen, making it more user-centric in addition to reducing a worsening level of driver distraction.

In other words, four different directions of view, like front, rear, driver's side and passenger's side, will be displayed in one touchscreen with three vertically split windows. Better yet, it can enable each capture of real-time images to be controlled by finger actions in a user-friendly way, as opposed to reflected images in auto mirrors. Digitizing images associated with driving and vehicle traffic may open a new era for data mining purposes of the driving data thus generated on a touchscreen.

As mentioned above, the transitional phenomenon of “dashtop sprawl” could be streamlined with this invention to help reduce distracted driving and thus enhance driving safety, which means ultimately reduced traffic jams and better fuel economy as a result.

The conventional way of adjusting mirrors using a control button located close to the steering wheel column is considered risky and distractive for a driver at the wheel. However, this invention can help drivers do that nimbler, safer and more dexterously at their fingertips. One hand at the wheel and another hand on the in-dash touchscreen enabling a full visibility may sound a lot safer than when a driver is in a situation, where one hand is grabbing the wheel, but another hand and both eyes are focused on a mobile handset that is irrelevant to driving visibility. A mirrorless car can surely eliminate a need to readjust mirrors and simultaneously get a full visibility.

Unlike auto mirrors, digital lenses coupled to a touchscreen can enable a closed loop control or feedback control. One moment a finger touch can change viewing angles and distances. The next moment the screen display content reverts automatically to a default setting without any redundant control, as opposed to the ongoing auto mirror adjuster mechanism. Of course, quickening of the reversion process can be forced by finger touches.

More finger jobs may arguably be the cause for increased driver distraction. But it doesn't follow that all the parameters contributing to driver distractions are detrimental. Some of them, like looking at an instrument panel or a navigation screen, are in positive territory and crucial to driving safety. An optimal use of finger actions on a touchscreen, while at the wheel, can help drivers in many positive ways.

And tactile senses can give more user-centric solutions than serially processed front-end voice activation, especially in a situation requiring faster error-free responses and handling multitasking urgencies while at the wheel, particularly amid boisterous traffic noises and nerve-racking environments.

On the contrary, texting on a smartphone while behind the wheel is inarguably dangerous or even fatal. Ironically enough, finger jobs on an in-dash screen might deter any compulsion to read and respond to text messages just arriving on any handheld device. Both hands are basically for driving, but as a driver gets more driving experience, one hand might tend to go idle. Ironically, the finger jobs relevant to this invention may help keep one idle hand from doing something detrimental to driving, like texting on a hand-held mobile device.

Speech technology can efficiently handle text-to-speech and speech-to-text conversions and is expected to expand the current scope of its applicability to include drivers at the wheel. However, the speech technology for drivers can hopefully be limited to none other than driving to minimize its harmful effect. It is remindful some technologies may have a long-term ill effect added to a short-term advantage.

The uptime efficiency of controlling viewing angles and distances instantaneously at fingertips on the touchscreen will help drivers feel safer with a full visibility thus gained, stay clear of blind spots, enlarge real-time views, get protection from sun glare and headlamp glare emanating from auto mirrors, and get a highlighted and more focused view of any desired spots.

Of course, drivers will get total freedom from frosty, frozen, wet and blurry side-view mirrors. And that from heated wing mirrors as well. Even though auto mirrors were completely removed, sun glare from shiny chrome decorations, reflective surfaces, windshields and rear windows wouldn't be completely gone. The persistence of this type of sun glare from other sources than wing mirrors can be addressed by holistic approaches outside this invention.

If a driver were against finger jobs relevant to this invention, like dragging and tapping on the screen, believing such finger actions are the causes for diverted attention, then he might as well elect to rely on just default display settings, either for good or until he can get more familiar and feel safe with finger jobs.

EVs and hybrid vehicles can save a lot of energy, compared with gasoline engines. According to Wikipedia, “due to efficiency of electric engines as compared to combustion engines, even when the electricity used to charge electric vehicles comes from a CO2 emitting source, such as a coal or gas fired power plant, the net CO2 production from an electric car is typically one half to one third of that from a comparable combustion vehicle.”

However, the combustion engines will still be more prevalent than EVs and hybrids during this decade ending in 2019. That means an era of fossil-fuel-free vehicles won't come that easy within this decade. Even when and if EVs were to hypothetically account for 100% of cars globally, efforts for vehicle body weight reduction wouldn't stop there. A scientist said “Twenty years from now we might have completely autonomous vehicles, maybe on limited roads.”[ Collision in the Making Between Self-Driving Cars and How the World Works Jan. 23, 2012 By JOHN MARKOFF, NYT]

### Advantageous Effects of Invention

The net gain in fuel economy is estimated at somewhere between 5% and 10%, with both the said drag and mirror weight thus removed, together with reduced traffic congestions as a result of improved driving safety on the strength of a full visibility thus gained.

It is noted the drag force increases with the square of velocity, meaning that doubling a vehicle speed will quadruple the resultant drag force. To compute the above percentage approximation, a reference area and a drag coefficient are based on Toyota Camry Sedan V40 (1994-1998).

If globally combined together, even 5% reduction in energy consumption would amount to 16.65 billion US gallons per year totaling US$66.6 billion at a current value. These figures are based on a global tally of registered automobiles on the roads at 1.015 billion as of 2010.

Also taken into account is the annual fuel consumption per vehicle averaged out at 330 US gallons. And a reference US fuel price was set at US$4.00/gallon as of 2011. Gasoline prices normally double up in other industrial countries. Statistical data from Plunkett Research, Ltd. were extrapolated to approximate the above figures.

The fuel efficiency thus obtained will contribute directly to reducing GHG emissions by as much, even allowing for EVs and hybrids that will hopefully represent 30% of the total vehicles by 2020 and subsequently reduce GHG emission by a one-third or a half by then. Given the current rate, a global total of passenger vehicles will most likely have reached 2 billion by 2020.

As of 2009, the annual emissions of CO2 gas alone per average passenger vehicle, including light trucks, were estimated at 5.5 M/T by DOT and 5.48 M/T by EPA, respectively. Given the DOT rate, a 5% reduction of GHG emissions will amount to 275 million M/T, based on the 2011 estimate of motor vehicles running globally.

The real-world implementation of this invention may be a lot easier and faster in view of the increasing economic viability and affordability of electronic parts and components. Major components of this invention, like touchscreens and digital camera lenses, are getting cheaper and more powerful over time. The initial transition costs might be higher, when compared with sticking with auto mirrors, but the transition will assuredly be rewarding enough to outshine the initial costs in terms of fuel economy and environmental initiatives.

Smartphones and tablet computers have brought down the current unit costs of such components to somewhere between $4 and $17 apiece and over time, the costs will drop further drastically.

Tooling costs and wiring jobs related to this invention will remain minimal, since moving parts are eliminated, except when otherwise required in an implementation stage. And the mounting positions of digital lenses are in close proximity to the existing power connections. Better yet, structural design of vehicle body won't be adversely affected by the 17 digital lenses, when mounted.

Besides, rearview backup cameras and vehicle black boxes would be desirably incorporated into this invention so as to push the envelope and achieve bigger economies of scale, when compared with the said two devices being implemented independently.

Such “fleet operations” technology as vehicle platooning (also known as road trains in Europe) and driverless driving could gain momentum and the biggest economies of scale, if incorporated into this invention that relies more on real-time V2V connectivity than GPS technology.

In USA, rearview backup cameras are proposed by NHTSA for a phase-in mandate and are tentatively scheduled to be fully mandatory from 2014 onward. This is due mainly to heavy annual fatalities reported at around 300 plus 18,000 injuries as a result of back-over accidents. This invention can incorporate the rearview backup camera to help expand its single-purpose use confined to backups on driveways and parking lots to include all the roads so as to achieve more economies of scale.

Also, it can give more user-centric features to EDRs. Currently, EDRs are limited to monitoring drivers and liability issues, thereby increasing chances of an escape mechanism and privacy concerns among drivers. User-centric features of this invention will not just address the privacy concerns related to EDRs but also broaden scope of data logging and data mining to help optimize the ITS objectives of making vehicle traffic smarter.

If driver attention, instead of being drawn to three to four different directions of view, were to be focused on one touchscreen supported by real-time data feeds, either self-generated or peer to peer, can arguably further improve driving safety and user-centric convenience, reducing traffic congestions, environmental pollution, fatalities, and financial damages resulting from traffic accidents.

If objectives of ITS were to make a national transportation system smarter, this invention, if enabled with web access, would play a pivotal role of so much needed connectivity nodes to leverage wireless V2V connectivity.

Then, data feeds of traffic updates from both roadside CCTVs, local traffic control centers, and cloud-based infrastructure can also be utilized on top of self-generated digital images and P2P data events. In short, images in auto mirrors can't do anything for data mining purposes, but digitized real-time images self-generated from this invention will open a new avenue for smarter traffic control and management.

The connectivity nodes thus enabled will help implement a mixed reality in the form of graphic or video images inclusive of virtual road signs, self-generated alerts, warning signs in an A/V format or alternatively at a choice of either audio or video.

The V2V connectivity thus enabled will form a solid basis for the scalability of cost-effective unmanned traffic control and management, which may include a method of issuing wireless citations without disrupting ongoing traffic and a method of alerting or advising drivers using graphic images like “virtual on-screen delineator posts” , for instance, that can be superimposed or overlaid over real-time images displayed on a touchscreen, as part of the above-mentioned mixed reality.

### BRIEF DESCRIPTION OF DRAWINGS

FIG. 1 Dragging Up and Down Within Borderline To Zoom In And Out

Dragging a finger way up on any of three split windows will show a real-time on-screen image farther, whereas dragging way down will show a close-up image.

FIG. 2 Dragging Up And Down To Hit Borderline To Get Panoramic Views

Dragging way up to hit the screen borderline in each of three split windows will display a panoramic front view, whereas dragging down to hit the same at bottom will generate a panoramic rearview.

FIG. 3 Dragging Left And Right To Expand One Window Sideways

Dragging left or right in any window will gradually expand an on-screen image by stages to finally merge the adjoining window to get a 2-window-wide view at maximum. Both driver's side view and passenger's side view will only merge the center window, but the center window for rearview will do that either way.

FIG. 4 Press And Hold To Get Tilted Views

To get tilted views to remove blind spots in 8 directions, one of the arrowheads in each window will be pressed and held. To quit this tilted view, press the center as shown.

FIG. 5 Double-Tapping To Get Full-Screen View

Double-tapping of any of three split windows will get a full-screen view of either driver's side, rear or passenger's side . To quit, tap once.

FIG. 6 Circling To Highlight And Get Close-Ups

At night, the entire screen will be automatically dimmed to suit a driver's surroundings in accordance with automated brightness control embedded. If the driver wants to see a highlighted view, he will circle around a desired spot, and tap once, twice or thrice to get an enlarged view by a factor of 2, 4 and 6. The triple-tapping will be a maximum to discourage further distractions. To quit, tap once outside the circled spot.

FIG. 7 Mounting Positions of Lenses—plan view of vehicle

During an implementation stage, mounting positions of digital camera lenses can be so adjusted as to fit a specific vehicle model. The plan view positions indicated are for reference only.

FIG. 8 Mounting Positions of Lenses—lateral view

This lateral view shows the mounting heights of lenses installed.

FIG. 9 Cross-sectional View of Lens Ball

The lens ball shows an array of backward-facing five lenses and a forward-facing single lens at the opposite end.

FIG. 10 Left-Side Lens Ball Facing Backward

The left-side or driver's side lens ball in lieu of a left wing mirror shows how a crisscross array of five lenses is arranged and is to replace a left wing mirror.

FIG. 11 Left-Side Lens Ball Facing Forward

FIG. 12. Graphic Images Superimposed on Real-Time Images

FIG. 13 Viewing of Remote Scene in Popup

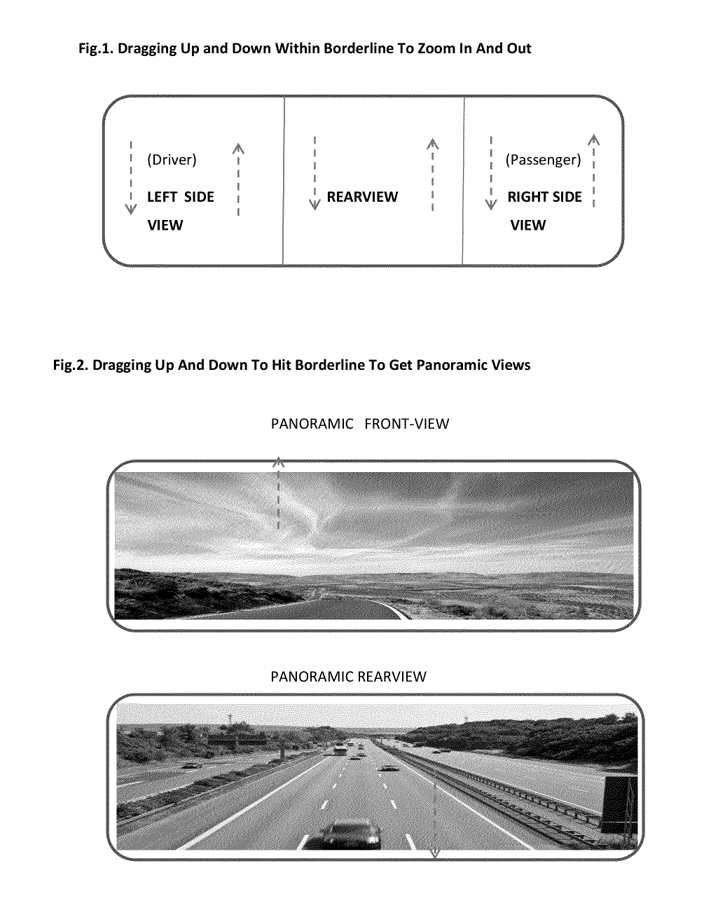

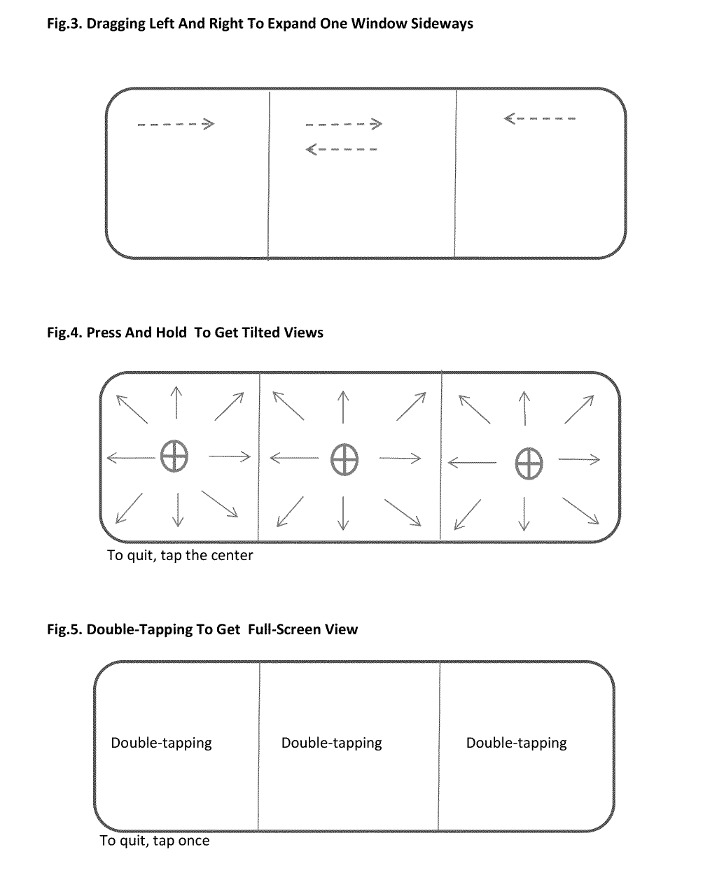

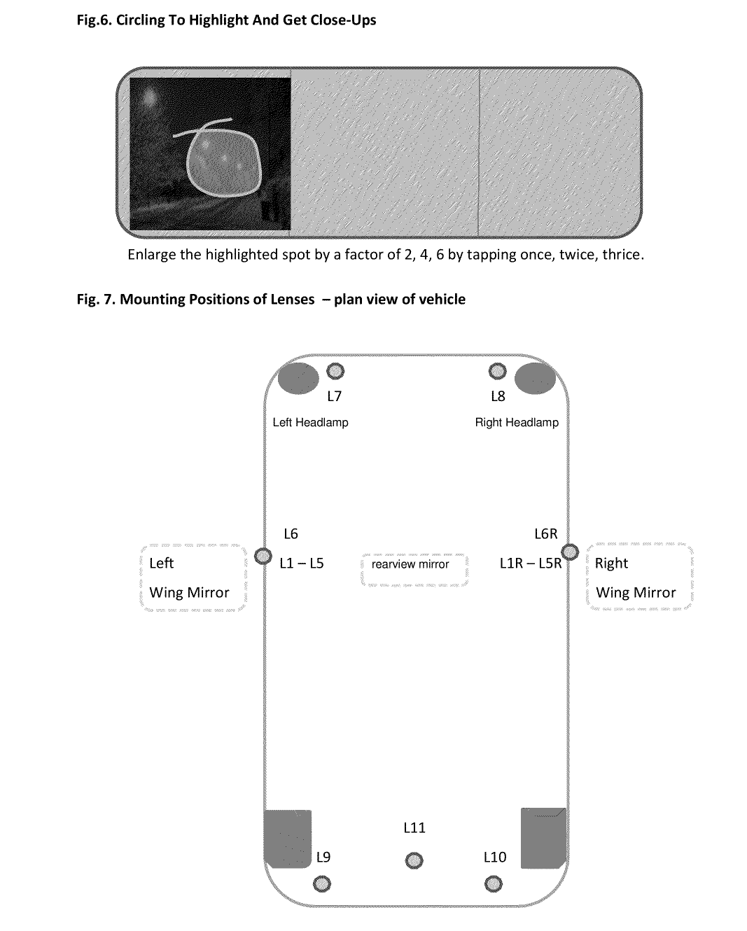

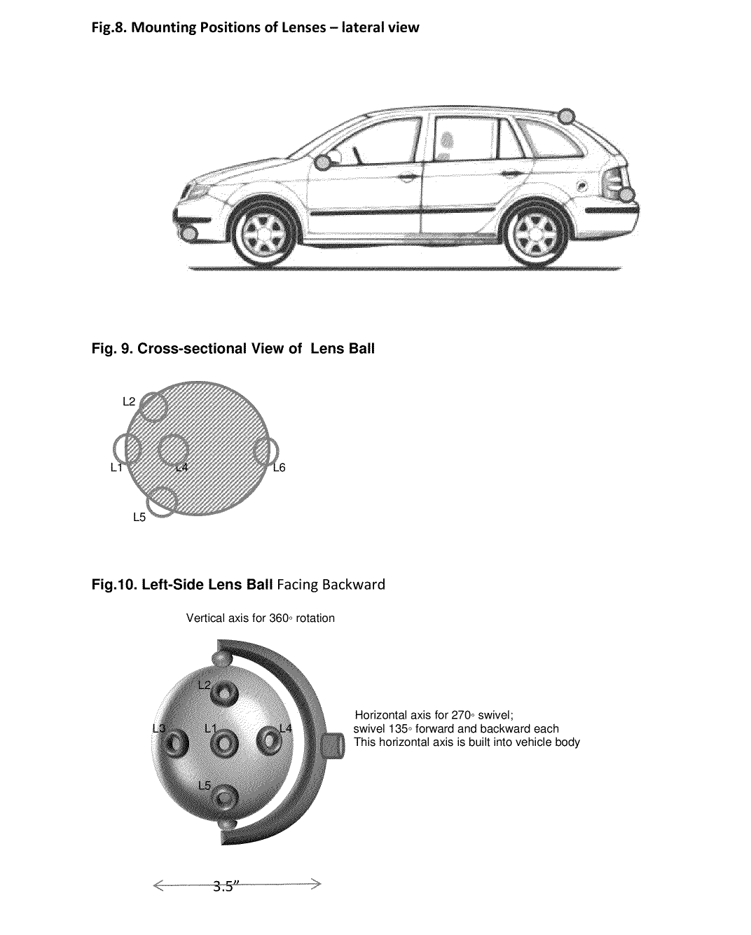

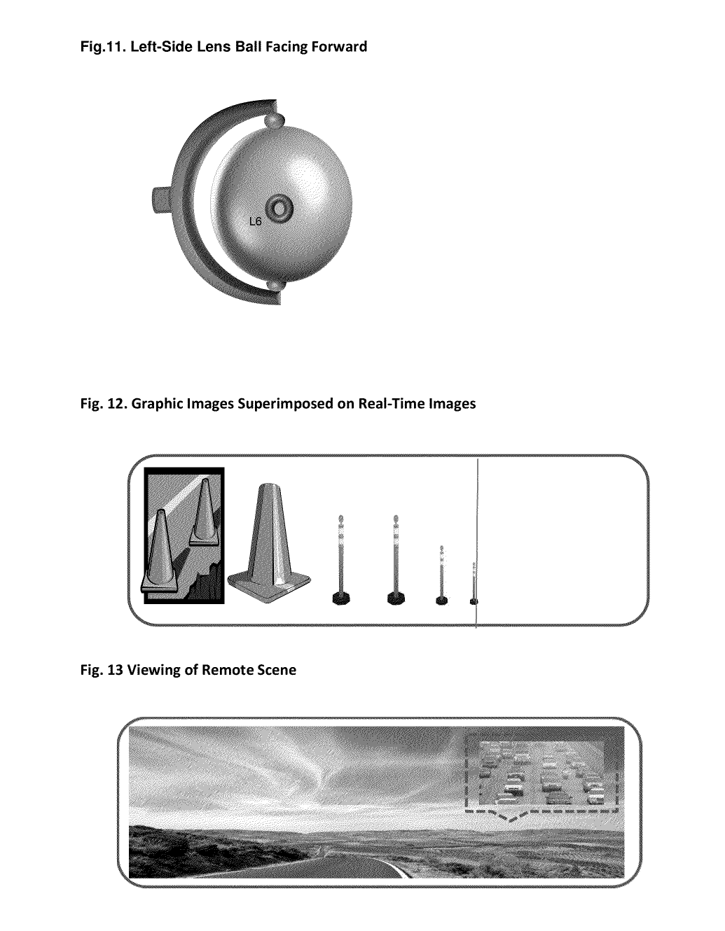

### DESCRIPTION OF EMBODIMENTS

### EXAMPLES

This invention envisions a chameleon's eye-view for a driver at the wheel so as to help gain a full visibility in the four directions of left, right and rear plus front in one screen encompassing three vertically split windows at a default setting. The split screen measures 12″ (W)×5″(H)×½″ (D) at minimum and needs to be equipped with an automated dimmer or brightness control mechanism, and an IR or UV filter or glare filter.

A total of 17 fixed digital camera lenses are mounted at seven locations as per FIG. 7. A lens ball with a crisscross array of 5 lenses facing backward in the direction of motion is to be mounted at a position, where a wing mirror, right or left, is currently mounted. The lens ball has a fixed single lens at the opposite end facing forward in the moving direction.

The 17 lenses are fixed and do not rotate or swivel, whereas the lens ball can rotate 360° on its vertical axes with its bracket designed to swivel 135° forward and backward, respectively. All the real-time captures of images are not necessarily displayed on the touchscreen, but only the captures selected as per a default setting are displayed, and more can be shown by finger actions through a combinatorial algorithm.

The touchscreen should NOT be incorporated into a currently available multifunction screen for navigation and IVI features, but should be built next to the steering wheel as a stand-alone unit in consideration of driving safety. Its exclusive use for viewing all directions surrounding a driver without any interruption from IVI features needs to be guaranteed.

And, depending on the mounting positions of gear shifters, like column-mounted, floor-mounted, console-mounted and instrument-panel-mounted, the screen should be positioned adequately to fit in with a driver's seating arrangements that may vary from vehicle to vehicle.

Finger actions applicable with this invention are as below:

1) Tapping, double tapping, and triple tapping

2) Dragging left/right, and up/down

3) Dragging up/down across borderline

4) Press and hold

On-screen displays responsive to tactile feedback are to continue for 10 seconds each, and revert to their respective default settings, unless a user and/or driver wants to quit the selected. Or else duration can be otherwise and variably specified.

Real-time image stabilizers, either digital or mechanical, are a must to prevent frame-to-frame jitters. Graphic images, like virtual on-screen delineator posts for extreme weather driving, can be self-generated responsive to location information to be superimposed on real-time image display so as to warn, caution, alert or advise a driver on the ongoing driving behavior, traffic and weather situations, and any lurking traffic hazards.

Web connectivity compatible with a black box functionality, vehicle platooning, wireless V2V connectivity, V2G for energy sharing, and cloud-based data logging may be added during an implementation stage. Data feeds from roadside CCTVs and P2P data events from cars on the roads can be accommodated through web access.

RC servos are optional to automate position control of a lens ball. Enlarging, merging and zooming in/out of screen images are controlled by a combinatorial algorithm included in this invention. The front-view images can be stitched together in real time to provide panoramic views. So does the rearview. [forward-facing lenses from both lens balls and front-view lenses embedded under both headlamps can be stitched together or stitched together separately, like top front-view and bottom front-view to be separated from each other.]

Since tiny lenses are easy to be covered by dirt, and blocked or clogged by grimy stuff, water and other elements, weather-proofing care and special protection from dirt, soil, oil, grime, water, rain, snow, frost, and age-related deterioration are crucial for their proper maintenance. A natural way of blow-drying can be achieved by designing a bracket holding a lens ball into a parabola cup, of which details are specified later on.

### Example 1

A multi-lens architecture dubbed a lens ball featured with a crisscross array of five lenses, fixed and facing backward, is provided on a 2″-radius sphere as per FIG. 10. At the opposite end of the multi-lens array is a fixed single lens facing forward. The lenses built in the lens ball don't swivel and rotate, but the bracket can swivel back and forth within 270° and the lens ball itself can rotate 360° on its vertical axes. [panning considered for inclusion] [zoom lenses for consideration] [zoom in and out][Doppler Effect in capturing images][rear top lens L11 can be bidirectional for front and rear]

Two lens balls are needed, one each for Driver's side (left) and passenger's side (right), while a single-lens system is provided for each of five other mounting locations. The two headlamp lenses (L7 and L8) are located under both headlamps, while a single fixed lens mounted on a lens ball is called a front-view lens (L6 for the left side and L6R for the right side) to differentiate between them.

The lens ball is bracketed into vehicle body, where side mirrors are currently mounted. The bracket can be designed in the shape of a parabola cup that can adjust forward and backward 15° to help blow-dry the lens ball by using natural wind pressure caused while driving. The parabola cup may be controlled on the touchscreen utilizing RC servomechanism because extreme-weather driving might require more blow-dry processes.

The touchscreen, if the lens ball is equipped with RC servos, can be designed as a control board to make the lens ball rotate 360° horizontally and 270° degrees vertically. When a vehicle turns left or right, the crisscross array plus the forward-facing lenses will help gain literally all-around views by eliminating dead angles, as opposed to wing mirrors causing “turn-by-turn” blind spots. No auto mirrors except for those embedded into sun visors are provided for in implementing this invention.

Automated delineator guides in the form of on-screen glowing orange dotted and solid lines will warn drivers of changing safety distances, in the four directions of front, rear, left and right, and will also represent virtual on-screen delineator posts to guard against any roadway borderlines. Driving aligned with a delineator guide may also enable vehicle platooning.
Cloud-based augmented reality can be considered. Heavy rain and thick fog. (Multiple-vehicle collision or pileup. wikipedia)
virtual delineator posts will show up on the screen to warn or alert a driver, if he or she tailgates or gets closer to a vehicle in the next lane. Virtual delineator to be shaped like what? Solar LED road markers, road reflectors,

### Example 2

Without any lens ball, a single-lens architecture for each location may have a merit in an early stage of transition, when a technological shakedown is early on. No multi-lens array is considered for both left and right sides. This single-lens-per-location architecture may require a total of nine digital lenses for seven locations shown in FIG. 7.

The single-lens system for the left and right sides can rotate 360° horizontally and 270° degrees vertically, using RC servomechanism. No auto mirrors are allowed except for sun visors. The front-view images can be stitched together in real time for panoramic views. So are the rearview images.

As an alternative throwback solution to give a temporary relief during transition, wing mirrors can be arranged to co-exist with this invention and be designed to fold down into vehicle body either automatically or button-controlled when a vehicle reaches a normal highway speed, starting at 50 mph, for example. However, the economic viability of this atavistic solution has yet to be quantified, verified and vindicated.

### INDUSTRIAL APPLICABILITY

rearview backup mirror

vehicular black box

on-screen delineator posts

vehicle platooning or road trains

### REFERENCE SIGNS LIST

AACR
Advanced Automatic Crash Response

Allview™
A third party trademark for enhanced rearview mirrors

Auto holism or automotive holism
The term is an inventor-initiated tenet for curing defects in automotive design and engineering, emphasizing a collective raison d′être of motor vehicles as a constituent part of road traffic.

EPA
Environmental Protection Agency

IVI
In-Vehicle Infotainment

DOT
Department of Transportation

EV
Electric Vehicle

CO2
carbon dioxide gas

Drag equation
One way to deal with complex dependencies is to characterize the dependence by a single variable. For drag, this variable is called the drag coefficient, designated “Cd.” This allows us to collect all the effects, simple and complex, into a single equation. The drag equation states that drag D is equal to the drag coefficient Cd times the density r times half of the velocity V squared times the reference area A. (source: NASA)

D=Cd*A*0.5*r*V̂2

ITS
Intelligent Transportation Systems

PND
Portable Navigation Device

VDC
Volt Direct Current

What is claimed is:

1. An in-vehicle system for implementing mirrorless driving of an automotive vehicle, comprising steps of arranging one or more mounting positions respectively of:
a plurality of digital camera lenses or digital image sensors on a vehicular body;
a haptic touchscreen coupled to the system, the haptic screen enabling a plurality of split windows and popup windows to replace automotive side mirrors and rear-view mirrors;
and a plurality of lens balls, the spherical architecture of digital camera lenses, on a driver's side and a passenger's side on said vehicular body.

2. The system of claim 1, wherein enabling horizontal rotating and vertical swiveling of a plurality of lens balls is achieved, comprising steps of:
providing a vertical axis and a horizontal axis to a bracket supporting one or more said lens balls;
arranging a crisscross array of more than one lens on said lens balls;
installing a servomechanism, either RC servos or wired, to enable position control of each of said lens balls;
and implementing an all-weather mechanism in said bracket to clean, defog, and defrost lenses in extreme weather conditions,
and wherein an electromechanical structure of said lens balls is enabled to rotate or swivel independently from one another.

3. The system of claim 2, wherein hierarchy in displaying a multitude of images propagated from lens balls is determined by a sequence of Persistence of Vision.

4. The system of claim 1, wherein a haptic touchscreen is activated by one or more finger actions inclusive of “dragging, tapping, tapping & holding, and circling”, comprising steps of:
merging a plurality of split windows into one or more bigger split windows to zoom in or out;
magnifying a view of a highlighted spot of on-screen images by a factor of an even or odd number;
enabling a multitude of surplus images propagated from digital image sensors, the surplus images being deployed outside a screen borderline by default settings and thus being made invisible, to be viewed on-screen by said finger actions;
and displaying a panoramic front-view or rear-view, by digitally stitching together a plurality of images from two or more digital image sensors;
and wherein a digital control board in a digital or analog form factor is virtualized to partly or wholly replace conventional tasks of electromechanical control in an instrument panel, comprising steps of:
replacing a plurality of conventional mechanical devices, inclusive of buttons, knobs and gear shifters, into a human-to-computer interaction;
and implementing interface dividers between finger actions and voice commands;

5. The system of claim 4, wherein a virtual reality is enabled, comprising steps of:
virtualizing traffic signs, either permanent or temporary, and road hazards or obstacles so as to be displayed on a haptic touchscreen;
performing on-screen superimposition of digital maps or visual data events from both roadside CCTV and cloud-based data centers, regardless of whether said data events are being propagated either archived, just in time or in real-time;
and enabling remote viewing of any road accident scene or any abnormal traffic scene, occurring in real time, in a popup window form factor.

6. The system of claim 1, wherein digital camera lenses and a haptic touchscreen coupled to said system can incorporate a video-based EDR (Event Data Recorder) and a rearview back-up camera in sync in a user-centric privacy setting.

7. A method for incentivizing a driver's voluntary compliance with traffic regulations, comprising steps of:
generating a periodical self-evaluation report on said driver's own accumulative driving behaviors by recording data events from a plurality of on-vehicle digital camera lenses or digital image sensors, and a haptic touchscreen coupled to said sensors;
optionalizing said report to be used as either a self-review or a supporting evidence to quantify eligibility for short-term or long-term rewards from regulatory agencies and insurers;
enabling snapshots or video clips of a close-by vehicle or more engaged in a wrongful act of driving unintentionally captured on said driver's haptic touchscreen, with an option of submitting said snapshots or video clips as third-party evidence to regulatory agencies or insurers;
and synchronizing a multitude of application software associated with ADAS (Advanced Driving Assistance System) to be integrated so as to achieve incentivizing objectives.

8. The method of claim 7, wherein a multitude of on-vehicle digital image sensors and a haptic touchscreen coupled thereto are integrated to centrally collect sample data events of driving behaviors from voluntary drivers to implement pattern recognition from the thus collected data samples.
